(19) United States
(12) Patent Application Publication
(10) Pub. No.: US 2003/0070907 A1
(43) Pub. Date: Apr. 17, 2003

(54) Switch with a removable connector

(75) Inventors: Michel Rochard, Ruelle (FR); Didier Severac, Rueil-Malmaison (FR)

Correspondence Address: PARKHURST & WENDEL, L.L.P., 1421 PRINCE STREET, SUITE 210, ALEXANDRIA, VA, 22314-2805, US

(73) Assignee: SCHNEIDER ELEC. INDUSTRIES SAS, Rueil-Malmaison (FR)

(21) Appl. No.: 10/270,316

(22) Filed: Oct. 15, 2002

(30) Foreign Application Priority Data
Oct. 12, 2001 (FR) 01 13403

(51) Int. Cl. H01H 1/64

(52) U.S. Cl. 200/293

(57) ABSTRACT

Switch, more specifically a position switch, whose box is roughly prismatic. The box 10 has wings 15a,16a,13a at the back that define the external template of the box and the wings of a housing A in which a connector 30 fits. The connector is fitted so that it is detachable from the housing and has a built-in body between the wings 15a,16a,13a and has at least one surface 35,36 defining the external template of the box. A quarter-turn fixing device 40 is associated with the connector 30, and has latching tongues 43,44 that fit into the slots 15b,16b provided in the opposite fitting wings 15a,16a of box 10.

This invention concerns a switch, comprising a template box whose outer shape is roughly prismatic, equipped on the front part with a motion or object presence detection head, housing an electric switching assembly, equipped at the back with output contacts, and, with a removable cable connector on a back part to connect a cable to the output contacts.

It is usual to connect these switches to a wide variety of connectors, which differ depending on the type of connection, the number of pins, the length of the cable attached to the connector body, or even by the cable outlet direction, etc. In practice, this requires the manufacturer to produce a multitude of switch references because of the different connectors associated with them. Moreover, it is desirable to integrate the connector in the switch box, particularly to avoid any impractical protrusions in an industrial machine environment.

The invention aims to integrate the connector in the box of such a switch in a simple manner, enabling the box to be associated with various connectors, and the connector or the electric switching assembly to be changed, preferably without modifying the box.

According to the invention, the switch box determines a housing for the switching assembly and the connector, and for this purpose, has two large lateral surfaces, contributing to definition of the outer template of the box, and forming partitions at the back part of the box, used as fitting wings for the connector. The connector body is fitted so that it can be detached from the housing between the wings, equipped with at least one partition inside the roughly prismatic template of the box and fastened in the housing by a locking mechanism.

The connector therefore does not protrude from the prismatic template of the box and remains protected. It is preferable that a back surface of the body forms the back surface of the box, and a lateral surface of the body forms part of the lateral surface of the box, enabling the cable to come out via the back or side. The switching assembly and the connector body are preferably inserted one behind the other in the switch box housing, which has a rectangular cross-section, as they have cross-sections that are roughly identical and suited to the housing.

Connector assembly and disassembly are simplified by the locking mechanism, which is preferably provided at the back of the connector body, with a manoeuvre element, such as a quarter-turn rotational element, accessible from the back surface and at least one latching element able to engage on a stop element provided in a wing of the box. The latching element can then be formed by two tongues provided on the sides opposite the rotating manoeuvre element to each operate with a slot provided in the opposite wings, between which the connector body is fitted. A seal placed against the internal wall of the housing, next to the electric switching assembly, is pressurised by the connector body's locking mechanism.

The description given below is of a non-limiting production method of the invention, supported by the attached drawings.

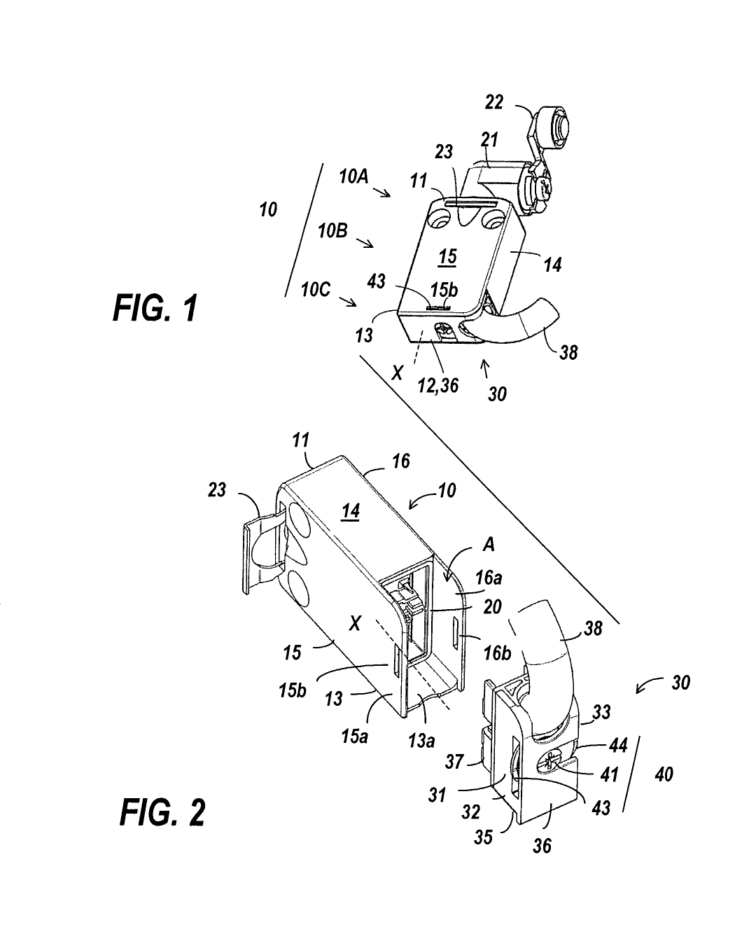

FIG. 1 shows a perspective view of a position switch according to the invention.

FIG. 2 is an exploded perspective view showing the switch box and connector.

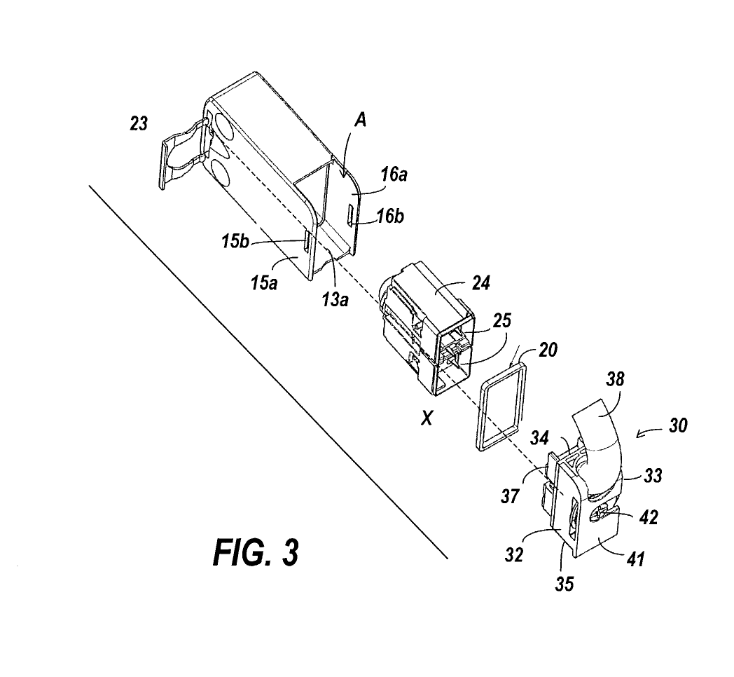

FIG. 3 is another exploded perspective view, on a smaller scale, of the switch.

The switch shown is a position switch, i.e. a switch with a lever or a push button sensitive to the approach of an external object, translating this detection into an outgoing electric signal. The switch considered may also be produced as a contact-less proximity sensor.

The position switch shown on FIG. 1 has a box 10, roughly prismatic in shape, with a front part 10A, a median part 10B and a back part 10C. On the front part 10A, a manoeuvre head 21 is fixed, equipped with a lever 22 that is able to rotate when an object comes into contact with it. The box 10 has a housing A, of a roughly rectangular cross-section, so that a contact block—or an electronic block—24 fits into the median part 10B of the box 10 (see FIG. 3) and a detachable connector 30 fits into the back part 10C of the box.

In greater detail, the box 10 of the switch has more or less flat surfaces: one front surface 11, one back surface 12, two small lateral surfaces 13,14 and two large lateral surfaces 15,16 forming a prismatic template—or casing—. The back part of the large lateral surfaces 15,16 each forms a fitting wing 15a,16a equipped with a slot-shaped opening 15b, 16b respectively, parallel to the adjacent back surface plane 12. The lateral surface 13 also has a fitting wing 13a on its back part, whereas the lateral surface 14 has no corresponding wing. Thus, the wings 15a,16a,13a define an opening towards the back and side of surface 14 for the housing A.

The manoeuvre head 21 is fixed so that it can be removed from the box 10 using a fork 23 that can be inserted into the box. The contact block 24 is inserted so that it can be removed from the box 10 in the main direction X of the switch, and has plug output contacts 25 at the back. A rectangular seal 20 is placed in the median part of housing A between the contact block 24 and the connector 30 to ensure tightness of the contact block. The contact block is, in this case, electromechanical; it may also include an electronic processing circuit.

The detachable connector 30 has a body 31 that is fitted and practically built into the housing A behind the contact block. The connector 30 has large lateral surfaces 32,33 that are engaged in the housing A, in parallel and adjacent to the wings 15a,16a of the large surfaces 15,16 of the box. It also has a small lateral surface 34 located in the extension of the small surface 14 of the box and a small lateral surface 35 engaged in the housing A, in parallel and adjacent to the wing 13a. The body 31 of the connector 30 has a back surface 36 that forms the majority, or preferably all, of the back surface 12 of the switch box. On the front, the connector 30 has socket contacts 37 to operate with at least some of the plug contacts 25 of block 24. A cable 38 is linked to the body 31 to come out at an angle of 45°, as shown on the figures, or parallel to the length of the box 10, depending on the type of connector required.

A locking mechanism 40 is provided at the back of the connector, associated with its back surface. The mechanism 40 is, for example, a quarter-turn rotating mechanism, and includes a manoeuvre screw, or similar device, 41, accessible from the back surface 36 and linked to a rotating cam 42 with two lateral lugs 43,44, that form the tongues latching in the slots 15b,16b. When the lugs 43,44 engage in the slots, the cam effect causes the front edge of the body 31 to be applied against the seal 20, resulting in satisfactory tightening of the seal. The mechanism 40 thus confirms fixture of the connector after plugging in and forms the seal of the electric part of the switch.

It should be observed that the contact block 24 and the body 31 of the connector 30 are roughly identical in length and width to the transversal cross-section of housing A of the box 10; by its back surface 36 and lateral surface 34, the connector fits in the prismatic template of the switch box, while remaining firmly held by the wings 15a,16a,13a and locked by the locking mechanism 40.

1. Switch with a roughly prismatic shaped template box, equipped on the front part with a motion or object presence detection head, housing an electric switching assembly, equipped with output contacts at the back, and with a removable cable connector on a back part, to connect a cable to the output contacts, characterised by the fact that:
the box (10) of the switch determines a housing (A) for the switching assembly (24) and the connector (30) and, for this purpose, has two large lateral surfaces (15,16) that contribute to the definition of the external template, the large lateral surfaces forming fitting wings (15a,16a,13a) on the back part,
the connector (30) has a body (31) fitted so that it can be detached from the housing (A) between the wings (15a,16a,13a), equipped with at least one surface (35,36) that fits in the external template of the box and held in the housing by a locking mechanism (40).

2. Switch according to claim 1, characterised by the fact that the body (31) of the connector fits into the housing (A) between the wings (15a,16a) of the back part (10C) of the switch box (10), a back surface (36) of the connector body forming the back surface (12) of the box and a lateral surface (35) of the connector body forming part of the lateral surface (14) of the box.

3. Switch according to claim 1, characterised by the fact that the electric switching assembly (24) and the body (31) of the connector are respectively housed in a median part (10B) and a back part (10C) of the switch box, being inserted one behind the other lengthways (X) in the switch, and being roughly identical in width and depth to the transversal cross-section of the box (10).

4. Switch according to claim 1, characterised by the fact that the locking mechanism (40) is provided at the back of the connector (30), this device comprising a manoeuvre element (41) accessible from the back surface (36) and at least one latching element (43,44) that engages on a stop element (15b,16b) provided in one wing (15a,16a) of the box (10).

5. Switch according to claim 4, characterised by the fact that the locking mechanism (40) is a quarter-turn fixing device.

6. Switch according to claim 5, characterised by the fact that the quarter-turn fixing device comprises two latching tongues provided on opposite sides of the rotating manoeuvre element (41) and each operating with a slot (15b,16b) provided in one wing (15a,16a) of the box (10).

7. Switch according to claim 1, characterised by the fact that a seal (20) is placed against the internal wall of the housing (A) adjacent to the switching assembly (24), between this assembly and a front part of the connector body (31). The locking mechanism (40) is able to apply pressure to the seal and thus ensure tightness of the switching assembly.
